(19) United States
(12) Patent Application Publication
(10) Pub. No.: US 2020/0379685 A1
(43) Pub. Date: Dec. 3, 2020

(54) STORAGE DEVICE

(71) Applicant: STMICROELECTRONICS (ROUSSET) SAS, Rousset (FR)

(72) Inventor: Julien MONTMASSON, Salon de Provence (FR)

(21) Appl. No.: 16/870,760

(22) Filed: May 8, 2020

(30) Foreign Application Priority Data
May 27, 2019 (FR) 1905583

(51) Int. Cl. G06F 3/06; G06F 21/62

(52) U.S. Cl. CPC G06F 3/0659; G06F 21/6218; G06F 3/0604; G06F 3/0673

(57) ABSTRACT

A device includes processing circuitry and a memory coupled to the processing circuitry. The memory includes an execute-only storage having a plurality of locations, each location storing an instruction. Data is stored in the execute-only storage by dividing the data into a plurality of portions. Each data portion is stored in one of the locations with a respective instruction.

### BACKGROUND

### Technical Field

The present disclosure generally concerns storage devices and more particularly devices comprising an execute-only memory.

### Description of the Related Art

There exist memories of several types, each being more or less accessible by a user. For example, read-only memories are non-volatile memories which cannot be written into. There exist memories from or into which a user may read and write. There also exist execute-only memories, configured, for example, by the manufacturer, so that a user can only execute the instructions stored in these memories, and not read or write them.

Execute-only memories may, for example, enable storing confidential software.

### BRIEF SUMMARY

An embodiment facilitates addressing all or part of the disadvantages of known storage devices.

An embodiment provides a storage device comprising an execute-only storage element 104, the storage element comprising a plurality of locations 111, 112, 116, each storing an instruction, wherein a data to be stored is divided into a plurality of portions 114, each portion 114 completing one of the locations 112.

An embodiment provides a method of storing data into an execute-only storage element 104, the storage element comprising a plurality of locations 111, 112, 116 each storing an instruction, the method comprising dividing the data into a plurality of portions 114, and storing each portion by completing a location 112.

According to an embodiment, the locations 111, 112, 116 have a same size.

According to an embodiment, the size of each portion 114 is smaller than the size of the locations 111, 112, 116.

According to an embodiment, the portions 114 of the data have no impact upon the results of the execution of the instructions.

According to an embodiment, at least some of the locations 112 comprising the portions 114 of the data comprise invalid instructions.

According to an embodiment, each location 112 comprising a portion of the data 114 comprises bits unused by the instruction stored in the location 112 completed by a portion 114 of the data.

According to an embodiment, the locations 112 comprising the portions of the data are successive locations of the storage element 104.

According to an embodiment, the successive locations 112 are preceded by at least one location 116 comprising an invalid instruction.

According to an embodiment, the portions 114 of the data are not located on the most significant bits of the locations 112.

According to an embodiment, a circuit 110 is configured to be able to read from and to write into the execute-only storage element.

According to an embodiment, the data correspond to information which is not accessible by a user.

The foregoing and other features and advantages will be discussed in detail in the following non-limiting description of specific embodiments in connection with the accompanying drawings.

In an embodiment, a device comprises processing circuitry; and a memory coupled to the processing circuitry, the memory including an execute-only storage having a plurality of locations, each storing an instruction, wherein data stored in the execute-only storage is divided into a plurality of portions, each data portion stored in one of the locations with a respective instruction. In an embodiment, the locations have a same size. In an embodiment, a size of each portion is less than the size of the locations. In an embodiment, a data portion stored with a respective instruction does not impact execution of the instruction. In an embodiment, one or more of the locations storing data portions store invalid instructions. In an embodiment, a data portion is stored in bits of a location which are not used by the instruction stored in the location. In an embodiment, the data portions are stored in successive locations of the execute-only storage. In an embodiment, the successive locations are preceded by at least one location storing an invalid instruction. In an embodiment, a data portion is not stored on a set of most significant bits of a location. In an embodiment, the processing circuitry comprises a secure engine configured to read from and write into locations of the execute-only storage. In an embodiment, the data corresponds to secret information. In an embodiment, the memory includes read storage, which, in operation, stores applications executable by the processing circuitry.

In an embodiment, a system comprises: a secure engine; and a memory coupled to the secure engine, the memory including an execute-only memory having a plurality of locations, each location storing an instruction, the execute-only memory storing data divided into a plurality of data portions, each data portion stored in one of the locations with a respective instruction. In an embodiment, the locations have a same size. In an embodiment, the locations storing data portions store invalid instructions. In an embodiment, the data portions are stored in successive locations of the execute-only memory. In an embodiment, the successive locations are preceded by at least one location storing an invalid instruction. In an embodiment, a data portion is stored on a set of least significant bits of a location. In an embodiment, the secure engine, in operation, reads from and writes into locations of the execute-only memory.

In an embodiment, a method comprises: storing instructions into individual storage locations of an execute-only memory; dividing data into a plurality of data portions; and storing the data portions with respective instructions stored in the execute-only memory. In an embodiment, the storage locations of the execute-only memory have a same size. In an embodiment, the storage locations are words of the execute-only memory. In an embodiment, the storage locations storing data portions store invalid instructions. In an embodiment, the data portions are stored in successive locations of the execute-only memory. In an embodiment, the successive locations are preceded by at least one location storing an invalid instruction. In an embodiment, the method comprises storing a data portion on a set of least significant bits of a storage location. In an embodiment, the method comprises, using a secure engine to read from and write into locations of the execute-only memory. In an embodiment, a non-transitory computer-readable medium stores instructions which configure a processing device to perform an embodiment of a method disclosed herein.

### BRIEF DESCRIPTION OF THE DRAWINGS

FIG. 1 schematically shows an embodiment of a storage device.

### DETAILED DESCRIPTION

The same elements have been designated with the same reference numerals in the different drawings, unless the context indicates otherwise. In particular, the structural and/or functional elements common to the different embodiments may be designated with the same reference numerals and may have identical structural, dimensional, and material properties.

For clarity, only those steps and elements which are useful to the understanding of the described embodiments have been shown and are detailed. In particular, the different circuits capable of accessing the memory are not described, since the memory can be associated with any type of usual circuit.

Throughout the present disclosure, the term “connected” is used to designate a direct electrical connection between circuit elements with no intermediate elements other than conductors, whereas the term “coupled” is used to designate an electrical connection between circuit elements that may be direct, or may be via one or more intermediate elements.

In the following description, when reference is made to terms qualifying absolute positions, such as terms “front,” “back,” “top,” “bottom,” “left,” “right,” etc., or relative positions, such as terms “above,” “under,” “upper,” “lower,” etc., or to terms qualifying directions, such as terms “horizontal,” “vertical,” etc., unless otherwise specified, it is referred to the orientation of the drawings.

The terms “about,” “substantially,” and “approximately” are used herein to designate a tolerance of plus or minus 10%, preferably of plus or minus 5%, of the value in question.

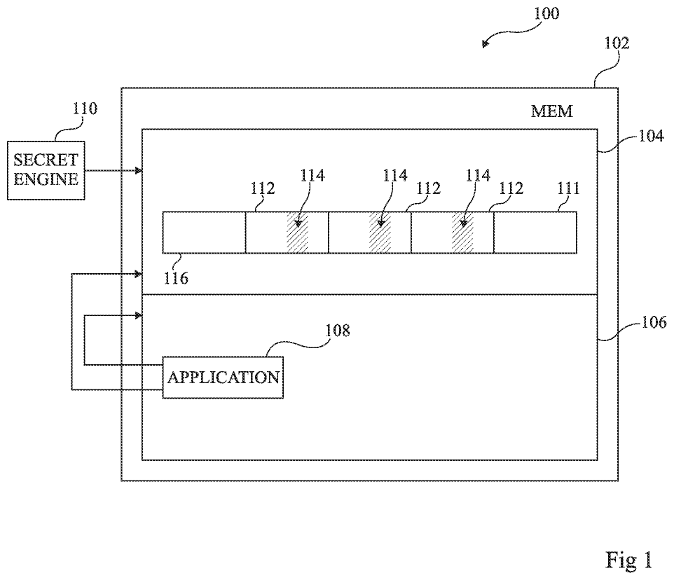

FIG. 1 schematically shows an embodiment of a storage device 100.

Storage device 100 comprises a non-volatile memory MEM 102 and processing circuitry such as one or more processors or processing core 120. Memory 102 is, for example, a Flash-type memory. Memory 102, as illustrated, includes memory management circuitry (MMU) 122, which in operation may, for example, control access to addresses in the memory (e.g., execute-only access, read only access, etc.).

Storage device 100 comprises an execute-only storage element. Storage element means a memory or a memory portion.

More particularly, in the example of FIG. 1, memory 102 comprises at least an execute-only portion 104. Execute-only memory or memory portion means a memory or memory portion comprising information or instructions which can only be executed, and which cannot be read or written by the users of the device. Portion 104, for example, comprises the codes of confidential software or data libraries, programmed and stored into the memory by the manufacturer.

The way for a user to modify a memory or a portion of an execute-only memory would be to fully erase the memory or memory portion to remove the restrictions. The user would however not have access to the data stored in the memory or memory portion, which would then have been erased.

The memory may comprise at last another portion 106, which is, for example, not an execute-only portion. Portion 106 is, for example, accessible to users. Portion 106 is, for example, a read-only memory, that is, a portion where it is possible to read information and to execute instructions (e.g., using the processing circuitry 120), but which cannot be written into. As a variation, portion 106 may be a portion where it is possible for a user to read, to write, and to execute information or instructions.

Portion 106, for example, comprises software 108 (APPLICATION) capable of reading and/or of writing and/or of executing the information stored in portion 106 when executed by the processing circuitry 120. Software 108 may execute the instructions stored in portion 104. Software 108 can however not read from or write into portion 104. Thus, it is not possible for a user to obtain the information contained in portion 104.

Memory 102, and in particular portion 104, comprises locations 111 where information, for example, instructions and operational codes, can be stored. In an embodiment, the locations 111 of portion 104 have a same size. In an embodiment, all the locations of memory 102 have a same size. The size of the locations is, for example, equal to 16 or 32 bits.

Device 100 comprises a circuit 110 (SECURE ENGINE). Circuit 110 is configured to be able to read from and write into portion 104.

Circuit 110 is not accessible and, in an embodiment, is not visible, by users. Circuit 110 is not accessible and, in an embodiment, is not visible by software 108 comprised within portion 106 of the memory. Software 108 can thus not control circuit 110. Software 108 can thus not use circuit 110 to read from or write into portion 104 and to have access to the confidential software stored in portion 104 of memory 102.

Circuit 110 is, for example, only accessible by the manufacturer. For example, circuit 110 receives software updates from the manufacturer.

Portion 104 may comprise at least one secret or confidential data, that is, which should not be accessible by users and by software 108, but which should be accessible by circuit 110. The data is, for example, an encryption key or a password. It is a value in binary form.

It may be chosen to store the secret data into one of locations 111, which would then only comprise said data. The data would then be stored as if it was an instruction. The data would then be accessible by circuit 110 by reading from this location. However, it would then be possible for a user to execute the data as an instruction and to determine the value of the data based on the impact of the execution of the data on the device.

For example, it is considered that the data correspond to hexadecimal value 0x1C58. This value, when it is executed, may correspond to instruction “ADD R0 R1 #1,” that is, the instruction which causes the addition of the values stored in registers R0 and R1 and stores the value obtained by the addition in register R0. It would then be possible, by observing the state of the device and in particular the state of the registers, to determine which instruction has been executed. It would then be possible, from the data in the form of instruction, to determine the value of the confidential data in binary form.

Such a way of storing the secret data is thus not secure and does not enable to keep the data confidential.

In an embodiment of a data storage method, the confidential data is divided into portions 114, each of portions 114 being located in a location 112, among locations 111 of portion 104 of memory 102. Locations 112 thus are locations 111 comprising a portion of the data. Each location 112 comprises an instruction. Each of portions 114 at least partially fills one of the locations 112 comprising an instruction.

When it is spoken of a first location located in front of, or before, a second location, this means that the first location has an address of lower value.

In an embodiment, all the data portions 114 have the same size, for example, 4 bits.

Each instruction stored in a location 112 may be located on the most significant bits of the location.

The instructions stored in locations 112, at least partially filled with one of the portions 114 of the data, are such that the presence of the portion of the secret data has no impact on the result of the execution of the instruction.

Each location 112 having a portion 114 of the data stored therein may be a location having bits unused by the instruction or bits which do not cause a different result on the execution of the instruction when the bits of the portion 114 change.

For example, if the size of location 112 is 16 bits and if the size of the instruction is 12 bits, the 4 remaining bits, for example, the least significant bits, may comprise one of portions 114 of the data.

Thus, portion 114 may occupy or fill all the unused bits of location 112.

As a variation, the portion may occupy a portion only of the unused bits.

For example, if the size of location 112 is 16 bits, and if the size of the instruction is 8 bits, the location comprises 8 unused bits, for example, the least significant bits. Thus, if portion 114 of the confidential data comprises 4 bits, the portion may be located on any of the 8 unused bits of location 112.

Each data portion 114 may be located on successive bits of the corresponding location 112. Circuit 110 is allowed to directly read locations 112.

The instructions associated with a data portion 114 may be invalid instructions in an embodiment. Invalid instruction means an instruction which has an impact on the system such that, for example, notifying the user of the presence of an error and/or stopping the execution of a sequence of instructions. However, the portion 114 is valid and has no impact. The result of an invalid instruction is the same whatever the content of the location following the bits of the invalid instruction and whatever the content of the location following the location comprising the invalid instruction.

Examples of invalid instructions or of invalid operational codes comprise, in hexadecimal form: 0xF87y, y representing bits with a value which has no impact on the instruction results. Other examples relates to codes 0xF8Fy, 0xF97y and 0xF9Fy. In practice, these are 32-bits instructions (for example, 0xF87yXXXX) but using the last 16 bits to hide secrete data may allow the secret data to be detected because an attacker could only execute these last 16 bits.

Each portion 114 of the data may be located on the least significant bits of location 112 or on internal bits, that is, bits which do not comprise the most significant bit and the least significant bit. The instruction stored in one of locations 112 is located on the most significant bits.

In an embodiment, the locations 112 where data portions 114 are located are successive locations of the memory.

In an embodiment, each location 112 comprising a portion 114 is preceded by:
at least one location 112 comprising another portion 114 of the data, or
at least one location 116 which comprises no portion 114 of the data.

Locations 116 comprise an instruction which has the same results when it is executed whatever the unused least significant bits, and whatever the content of the next location. More particularly, if a circuit executes the content of a plurality of locations for a same invalid instruction, starting with the location comprising the invalid instruction, the result will be the same whatever the content of the other location(s).

In an embodiment, the instructions stored in locations 116 are invalid instructions.

When a location 112 is preceded by at least one location 116, the number of locations 116 depends on the possibilities of reading of the circuits capable of executing instructions of portion 104. More particularly, the number of locations 116 located before successive locations 112 depends on the number of bits that can be executed on execution of an instruction.

It is considered in the following examples that a location comprises x bits, for example, x=16.

If the circuits and/or software accessible by the user, for example, the software located in portion 106, can only execute one location at a time, that is, can execute instructions having at most x bits, it may be chosen not to add a location 116 directly in front of locations 112.

If the circuits and/or software accessible by the user, for example, the software located in portion 106, can execute two locations at a time, that is, can execute instructions having at most 2x bits, it may be chosen to add at least one location 116 directly in front of locations 112.

More generally, if the circuits and/or software accessible by the user, for example, the software located in portion 106, can execute n locations at a time, n being an integer greater than or equal to 1, that is, can execute instructions having at most nx bits, it may be chosen to add at least n-1 locations 116 directly in front of locations 112.

It may be chosen not to place locations 116 in front of locations 112.

However, in the case where the circuits and/or software accessible by the user, for example, the software located in portion 106, can execute two locations at a time, if the locations 111 preceding a location 112 comprises an instruction for which the next bits, in particular the bits of the portion of the data of the next location 112, have an impact, it would then be possible to at least partially determine the data as previously described.

It may, for example, be chosen not to add a location 116 if the portion(s) 114 that can be known in this manner are not sufficient to known the full data or to be a problem.

Device 100 may contain more or fewer elements than illustrated, may combine illustrated elements or split illustrated elements in to more elements, etc. and various combinations thereof. For example, in an embodiment, the processing circuitry 120 and the MMU 122 may be combined. In another example, the secure engine 110 and the MMU 122 may be combined. In another example, the device 100 may include an interface to couple the device 100 to other components of a system (e.g., other components of a smart phone).

Various embodiments and variations have been described. It will be understood by those skilled in the art that certain features of these various embodiments and variations may be combined, and other variations will occur to those skilled in the art.

Finally, the practical implementation of the described embodiments and variations is within the abilities of those skilled in the art based on the functional indications given hereabove.

Such alterations, modifications, and improvements are intended to be part of this disclosure, and are intended to be within the spirit and the scope of the present disclosure. Accordingly, the foregoing description is by way of example only and is not intended to be limiting. The present disclosure is limited only as defined in the following claims and the equivalents thereto.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, convolutional accelerators, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
processing circuitry; and
a memory coupled to the processing circuitry, the memory including an execute-only storage having a plurality of locations, each storing an instruction, wherein data stored in the execute-only storage is divided into a plurality of portions, each data portion stored in one of the locations with a respective instruction.

2. The device of claim 1 wherein the locations have a same size.

3. The device of claim 2 wherein a size of each portion is less than the size of the locations.

4. The device of claim 1 wherein a data portion stored with a respective instruction does not impact execution of the instruction.

5. The device of claim 1 wherein one or more of the locations storing data portions store invalid instructions.

6. The device of claim 1 wherein a data portion is stored in bits of a location which are not used by the instruction stored in the location.

7. The device of claim 1 wherein the data portions are stored in successive locations of the execute-only storage.

8. The device of claim 7 wherein the successive locations are preceded by at least one location storing an invalid instruction.

9. The device of claim 1 wherein a data portion is not stored on a set of most significant bits of a location.

10. The device of claim 1 wherein the processing circuitry comprises a secure engine configured to read from and write into locations of the execute-only storage.

11. The device of claim 1 wherein the data corresponds to secret information.

12. The device of claim 1 wherein the memory includes read storage, which, in operation, stores applications executable by the processing circuitry.

13. A system, comprising:
a secure engine; and
a memory coupled to the secure engine, the memory including an execute-only memory having a plurality of locations, each location storing an instruction, the execute-only memory storing data divided into a plurality of data portions, each data portion stored in one of the locations with a respective instruction.

14. The system of claim 13 wherein the locations have a same size.

15. The system of claim 13 wherein the locations storing data portions store invalid instructions.

16. The system of claim 15 wherein the data portions are stored in successive locations of the execute-only memory.

17. The system of claim 17 wherein the successive locations are preceded by at least one location storing an invalid instruction.

18. The system of claim 13 wherein a data portion is stored on a set of least significant bits of a location.

19. The system of claim 13 wherein the secure engine, in operation, reads from and writes into locations of the execute-only memory.

20. A method, comprising:
storing instructions into individual storage locations of an execute-only memory;
dividing data into a plurality of data portions; and
storing the data portions with respective instructions stored in the execute-only memory.

21. The method of claim 20 wherein the storage locations of the execute-only memory have a same size.

22. The method of claim 21 wherein the storage locations are words of the execute-only memory.

23. The method of claim 20 wherein the storage locations storing data portions store invalid instructions.

24. The method of claim 23 wherein the data portions are stored in successive locations of the execute-only memory.

25. The method of claim 24 wherein the successive locations are preceded by at least one location storing an invalid instruction.

26. The method of claim 20, comprising storing a data portion on a set of least significant bits of a storage location.

27. The method of claim 20, comprising, using a secure engine to read from and write into locations of the execute-only memory.
